(19) United States
(12) Patent Application Publication
(10) Pub. No.: US 2022/0168081 A1
(43) Pub. Date: Jun. 2, 2022

(54) HANDS-FREE DENTAL SUCTION AND RETRACTION DEVICE

(71) Applicant: Hossein Javid, Inglewood, CA (US)

(72) Inventor: Hossein Javid, Inglewood, CA (US)

(21) Appl. No.: 17/535,976

(22) Filed: Nov. 26, 2021

Related U.S. Application Data
(60) Provisional application No. 63/118,846, filed on Nov. 27, 2020.

(51) Int. Cl. A61C 17/10; A61C 17/08

(52) U.S. Cl. CPC A61C 17/10; A61C 17/08

(57) ABSTRACT

An exemplary hands-free dental suction and retraction device includes a spray capture element, at least one oral partition element, at least one lateral suction tube, and a retraction shroud. The spray capture element may be curved around a longitudinal axis. The spray capture element may define a suction passageway therein and have a plurality of suction apertures each extending between the suction passageway and an outer ambient zone. The outer ambient zone may be defined between the spray capture element and the longitudinal axis. The oral partition elements have one or more suction perforations. An inner ambient zone is defined between the oral partition element and longitudinal axis. The lateral suction tube may be in fluid communication between the suction perforations and the suction passageway. The retraction shroud may extend about the longitudinal axis and be axially disposed at least between the spray capture element and the oral partition element.

### RELATED APPLICATIONS

This application claims the benefit of U.S. Provisional Application No. 63/118,846 filed Nov. 27, 2020, the content of which is incorporated by this reference its entirety for all purposes as if fully set forth herein.

### TECHNICAL FIELD

The present disclosure relates generally to the field of dental suction and retraction devices.

### SUMMARY

Certain deficiencies of the prior art may be overcome by the provision of a hands-free dental suction and retraction device, examples of which are disclosed herein.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is a diagrammatic perspective view of a first example hands-free dental suction and retraction device in accordance with the present disclosure;

FIG. 2 is a further diagrammatic perspective view of the dental suction and retraction device shown in FIG. 1;

FIG. 2A is a diagrammatic view of detail 2A in FIG. 2, but wherein the oral partition element includes a bite block element affixed thereto;

FIG. 3 is yet a further diagrammatic rear view of the dental suction and retraction device shown in FIG. 1;

FIG. 4 is a diagrammatic cross-sectional view taken along lines 4-4 in FIG. 3;

FIG. 5 is a diagrammatic side view of the dental suction and retraction device shown in FIG. 1;

FIG. 6 is a diagrammatic cross-sectional view taken along lines 6-6 in FIG. 5;

FIG. 7 illustrates the example dental suction and retraction device shown in FIG. 1 in use with the mouth of a patient, wherein the device and mouth are shown in cross-section along lines 7-7 in FIG. 5, and a source of suction is shown connected to the suction interface portions of the device;

FIG. 8 is a diagrammatic perspective view of a second example hands-free dental suction and retraction device in accordance with the present disclosure, wherein the device includes an auxiliary aerosol shroud;

FIG. 9 is a diagrammatic cross-sectional view similar to that of FIG. 4, but wherein the device is that of FIG. 8;

FIG. 10 illustrates the example dental suction and retraction device shown in FIG. 8 in use with the mouth of a patient, wherein the device and mouth are shown in cross-section in similar manner to that of FIG. 7, and a source of suction is shown connected to the suction interface portions of the device;

FIG. 11 is a diagrammatic perspective view of a third example hands-free dental suction and retraction device in accordance with the present disclosure, wherein the device includes a tongue retraction shroud;

FIG. 12 is a further diagrammatic perspective view of the dental suction and retraction device shown in FIG. 11;

FIG. 13 is a diagrammatic cross-sectional view similar to that of FIG. 4, but wherein the device is that of FIG. 11;

FIG. 14 illustrates the example dental suction and retraction device of FIG. 11 in use with the mouth of a patient, wherein the device and mouth are shown in cross-section in similar manner to that of FIG. 7, and a source of suction is shown connected to the suction interface portions of the device;

FIG. 15 is diagrammatic top view of the dental suction and retraction device of FIG. 11;

FIG. 16 is a diagrammatic side view of the dental suction and retraction device of FIG. 11;

FIG. 17 is a diagrammatic perspective view of a fourth example hands-free dental suction and retraction device in accordance with the present disclosure, wherein the device includes a tongue retraction shroud and a floor suction tube;

FIG. 18 is a further diagrammatic perspective view of the dental suction and retraction device shown in FIG. 17;

FIG. 19 is diagrammatic top view of the dental suction and retraction device of FIG. 17;

FIG. 20 is diagrammatic bottom view of the dental suction and retraction device of FIG. 17; and

FIG. 21 is a diagrammatic side view of the dental suction and retraction device of FIG. 17.

### DETAILED DESCRIPTION OF THE PREFERRED EMBODIMENTS

Referring now to the drawings, like reference numerals designate identical or corresponding features throughout the several views.

Various example embodiments of a hands-free dental suction and retraction device in accordance with the present disclosure are shown generally at 100 in the several drawings presented herewith. A dental suction device 100 may comprise a spray capture element 102, an oral partition element 112, an inner ambient zone 114, a lateral suction tube 116 and a retraction shroud 118.

The spray capture element 102 may be curved around a longitudinal axis 104. Referring to FIGS. 6 and 7, the spray capture element 102 may define a suction passageway 106 therein and may have a plurality of suction apertures (such as those shown, for example, at 108) each extending between the suction passageway 106 and an outer ambient zone 110. Referring to FIG. 7, the outer ambient zone 110 may generally be defined between the spray capture element 102 and the longitudinal axis 104.

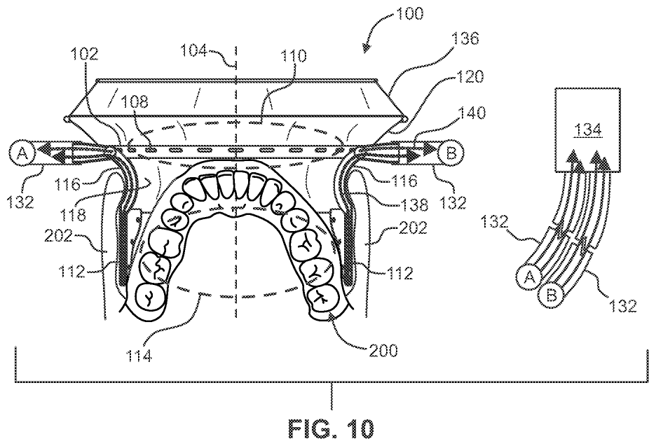

Referring to FIG. 4, one or more suction interface portions 126 may be in fluid communication with the spray capture element 102 and, where present, a lateral suction tube 116. The suction interface portions 126 may have an inlet end 28 and a discharge end 130. Referring to FIGS. 7, 10, and 14, the suction interface portion 126 may be configured to be placed in fluid communication with a source of suction 134, for example, by way of one or more suction conduits 132. The source of suction 134 may be a conventional dental suction unit typically incorporating a vacuum pump, or an equivalent dental suction unit developed at some point in future.

Referring to FIG. 4, the oral partition element 112 may have a plurality of suction perforations 124. The inner ambient zone 114 may be defined between the oral partition element 112 and the longitudinal axis 104. The lateral suction tube 116 may be in fluid communication between the suction perforations 124 and the suction passageway 106. The retraction shroud 118 may extend about the longitudinal axis 104 and may preferably be axially disposed at least between the spray capture element 102 and the oral partition element 112. The retraction shroud 118 may be comprised of a flexible polymer film, sheeting or the like.

Particular implementations of a dental suction and retraction device 100 may comprise an aerosol shroud 120 extending about the longitudinal axis 104. In such implementations, the spray capture element 120 may be axially disposed between the retraction shroud 118 and the aerosol shroud 120. The aerosol shroud 120 may preferably be comprised of a flexible polymer film, sheeting or the like.

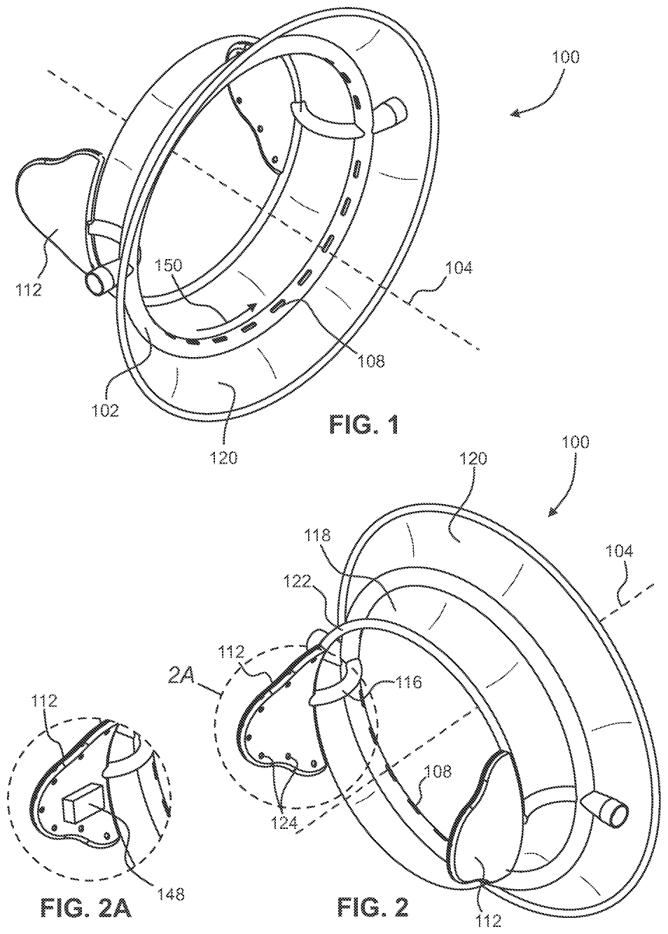

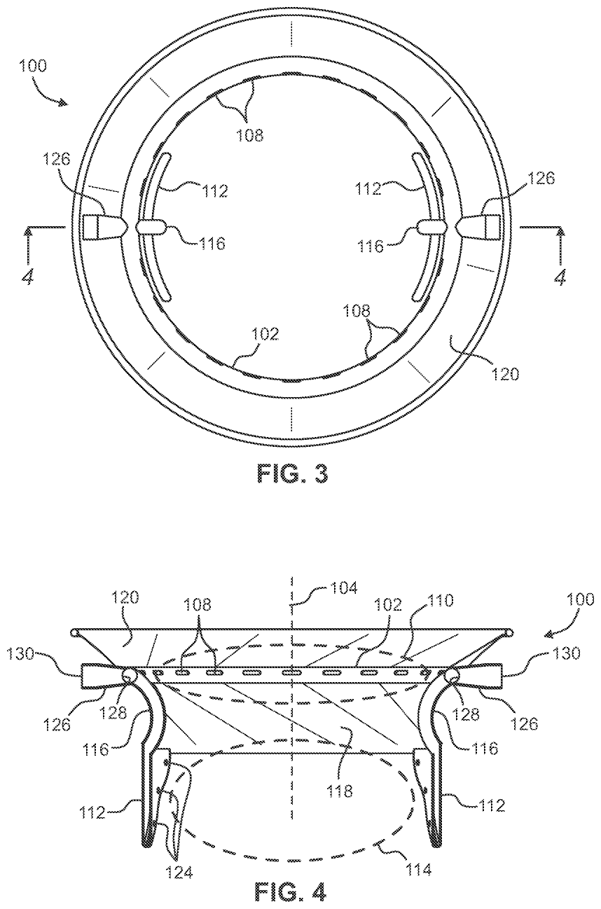

As shown, for example, in FIGS. 1 and 4, in certain implementations of the dental suction and retraction device 100, the spray capture element 102, the retraction shroud 118, and the aerosol shroud 120 may each extend completely circumferentially about the longitudinal axis 104. Referring to FIG. 6, the suction passageway 106 may be continuous (e.g., closed-loop).

Referring to FIGS. 2 and 4, particular implementations of the dental suction and retraction device 100 may comprise two oral partition elements 112 and two respective lateral suction tubes 116. In such implementations, the oral partition elements 112 may be disposed oppositely of one another radially of the main axis 104. In the alternative, it is envisioned that some implementations of the dental suction and retraction device 100 may only comprise one oral partition element 112 (e.g., to be disposed on one side of the mouth). In such cases, the device 100 may only comprise one corresponding lateral suction tube 116.

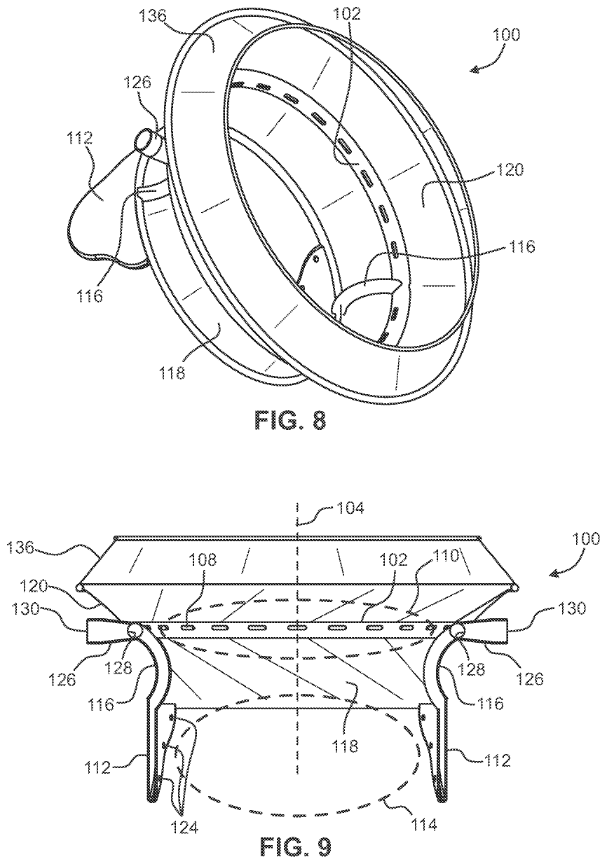

Referring now to FIGS. 8-10, certain implementations of a dental suction and retraction device 100 may comprise an auxiliary aerosol shroud 136 extending about the longitudinal axis 104. In such implementations, the aerosol shroud 120 may be axially disposed between the spray capture element 102 and the auxiliary aerosol shroud 136. The auxiliary aerosol shroud 136 may preferably be comprised of a flexible polymer film, sheeting or the like.

Referring to FIGS. 1 and 4, the suction apertures 108 may be elongated. This elongation may be in an arcuate direction 150 about the longitudinal axis 104. In implementations of the device 100 in which the suction apertures 108 are elongated, the suction apertures 108 may have an aspect ratio of at least 3:1. This aspect ratio may be defined as the length of the suction aperture 108 to the width of the suction aperture 108.

Referring to FIG. 2A, in particular implementations of a dental suction and retraction device 100, each oral partition element 112 may include a bite block member 148.

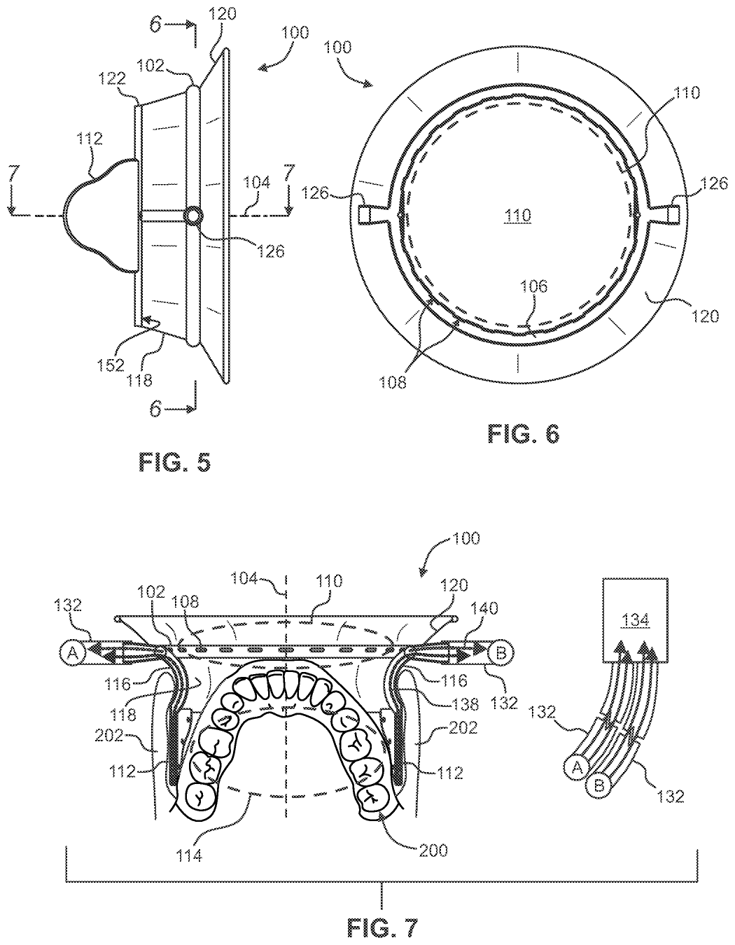

The retraction shroud 118 may be comprised of a flexible sheet material. Referring to FIG. 5, in such cases, the retraction shroud 118 may include an inner periphery 152 having a stiffener ring 122 attached thereto.

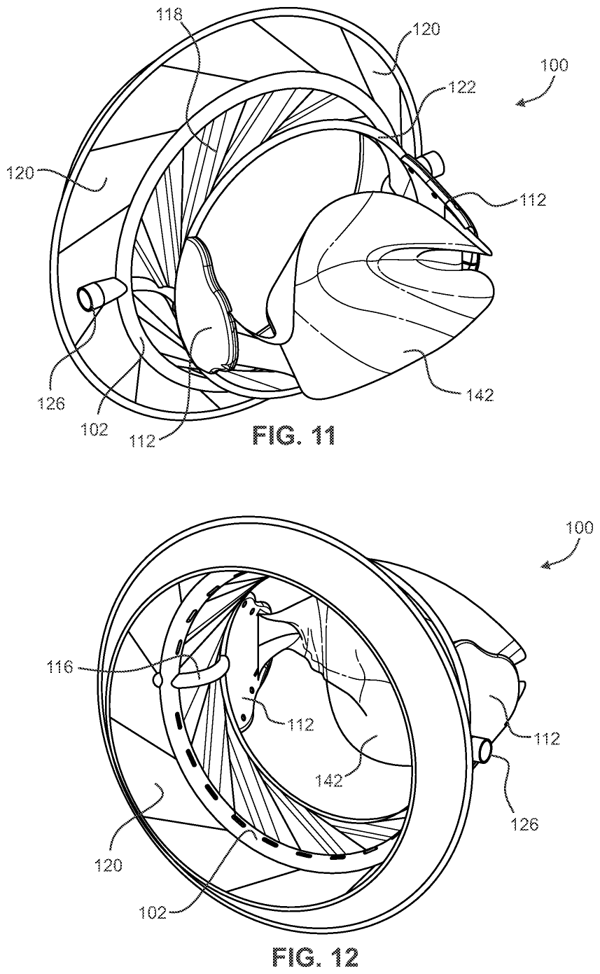

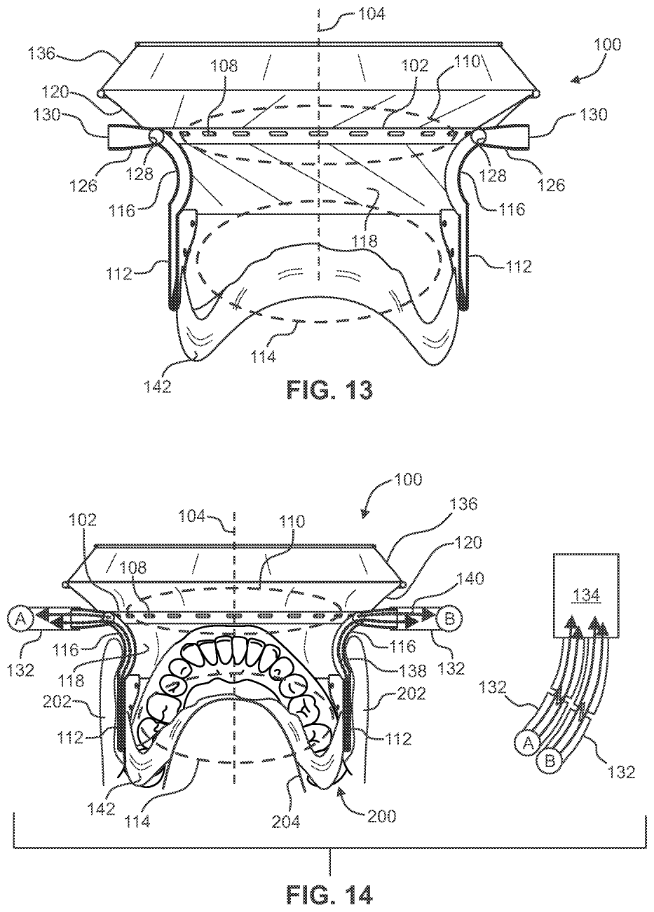

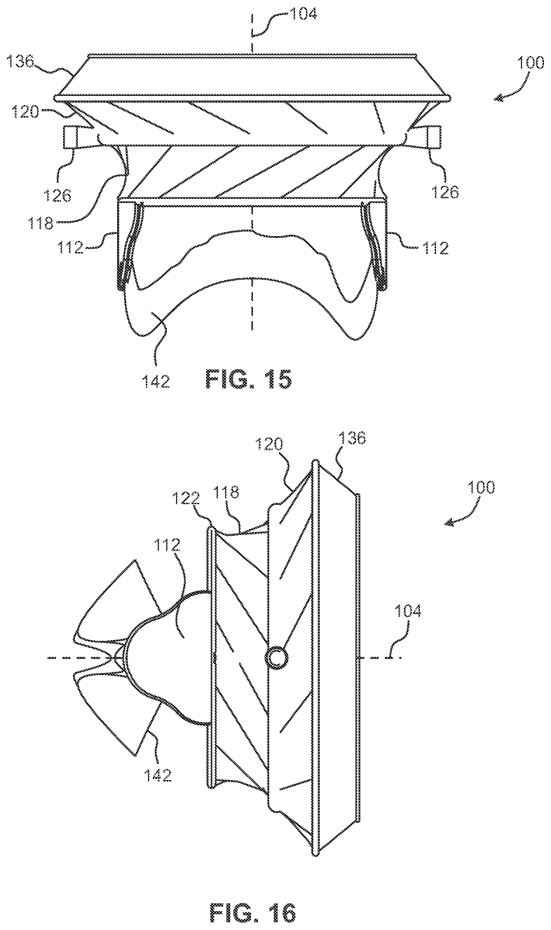

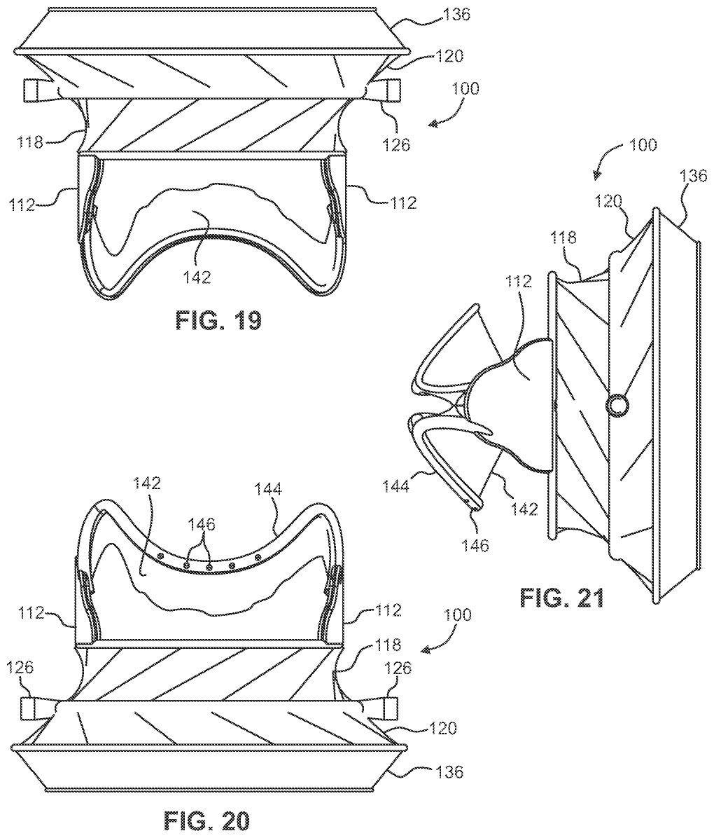

Referring to FIGS. 11-21, certain implementations of a dental suction and retraction device 100 may comprise a tongue retraction element 142. In such implementations, the tongue retraction element 142 may be laterally affixed to the oral partition elements 112. As illustrated in FIG. 14, the tongue retraction element 142 is configured to retain the patient's tongue in a rearward position within the oral cavity. The tongue retraction element 142 may be comprised of a flexible polymer film, sheeting or the like.

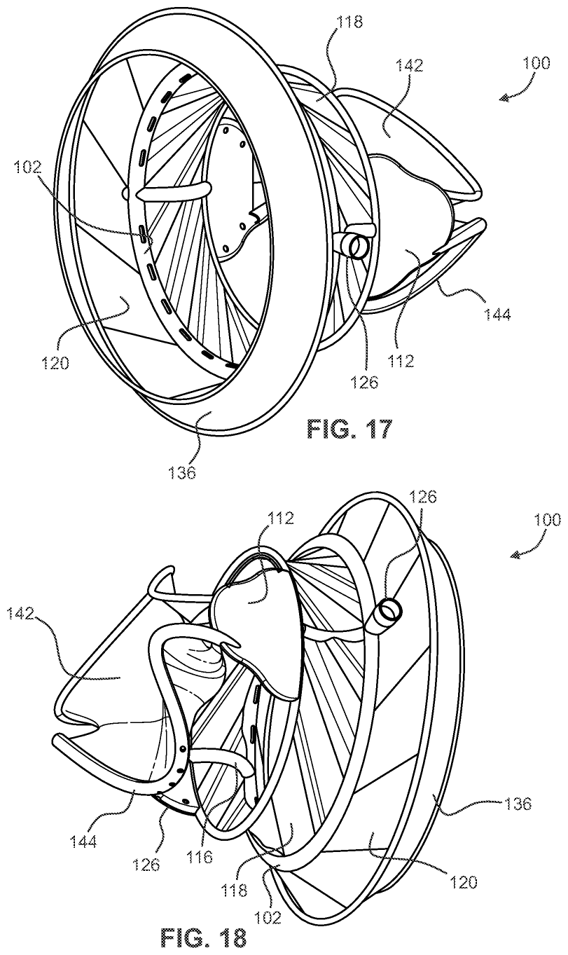

Referring to FIGS. 17-21, particular implementations of a dental suction and retraction device 100 may comprise a floor suction tube 144 having one or more suction openings 146. The interior of the floor suction tube 144 (and thus the openings 146) may preferably be in fluid communication with the suction passageway 106. Referring to FIG. 21, in such implementations having a tongue retraction element 142, the tongue retraction element 142 may include a lower portion and an upper portion, and the floor suction tube 144 may thus be attached to the lower portion of the tongue retraction element 144. The floor suction tube 144 is primarily designed to reside under the tongue 204 of the patient, and thereby draw intraoral fluids from the floor of the oral cavity during the dental procedure.

Referring to FIGS. 7, 10 and 14, respective examples of the dental suction and retraction devices 100 are illustrated in use on a dental patient during a dental procedure. The retraction shroud 118 maintains the patient's lips in a retracted open position. Generally, the oral partition element 112 is inserted and maintained within the oral cavity, either between a row of teeth 200 and the tongue 204 of the patient or between the row of teeth 200 and the cheek 202 of the patient (as shown for example in FIGS. 7, 10 and 14). The oral partition element(s) 112 may be comprised of a flexible polymer, so as to easily conform with the immediately adjacent features of the patient's mouth. During a typical dental procedure, excess saliva is suctioned from the oral cavity by way of the oral partition element(s) 112, and, where present in the device 100, also by way of a floor suction tube 144 (see, e.g., FIG. 21). Referring to FIGS. 2 and 4, the oral partition element(s) 112 may include suction perforations 124 therein for receiving the excess saliva. The excess saliva may be suctioned from the oral partition element 112 through the respective lateral suction tube 116 and to the suction interface portion(s) 126. At the same time, during the dental procedure, aerosol containing saliva, blood, debris and microorganisms may be expelled from the oral cavity and into the outer ambient zone 110. The spray capture element 102 suctions in this aerosol and directs it to the suction interface portion(s) 126. The suctioned excess saliva and aerosol is directed from the suction interface portions 126 to the source of suction 134 by way of one or more suction conduits 132 connected in fluid communication therebetween.

The following listing matches certain terminology used within this disclosure with corresponding reference numbers used in the non-limiting examples illustrated in the several figures.
100 dental suction and retraction device
102 spray capture element
104 longitudinal axis
106 suction passageway
108 suction apertures
110 outer ambient zone
112 oral partition element (e.g., suction plate)
114 inner ambient zone
116 lateral suction tube
118 retraction shroud
120 aerosol shroud
122 stiffener ring (e.g., at inner periphery of retraction shroud)
124 suction perforations
126 suction interface portion
128 inlet end (of suction interface portion)
130 discharge end (of suction interface portion)
132 suction conduit
134 source of suction
136 auxiliary aerosol shroud
138 intraoral flow path (e.g., of suctioned fluid and/or aerosol)
140 extraoral flow path (e.g., of suctioned fluid and/or aerosol)
142 tongue retraction element (e.g., tongue shroud)
144 floor suction tube
146 suction openings (e.g., along bottom of tongue suction tube)
148 bite block member
150 arcuate direction
152 inner periphery (of retraction shroud 118)
200 teeth (e.g., upper or over row of teeth of patient)
202 cheek (of patient)
204 tongue (of patient)

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A hands-free dental suction and retraction device comprising:
a spray capture element curved around a longitudinal axis, the spray capture element defining a suction passageway therein and having a plurality of suction apertures each extending between the suction passageway and an outer ambient zone, the outer ambient zone being defined between the spray capture element and the longitudinal axis;
an oral partition element having a plurality of suction perforations;
an inner ambient zone defined between the oral partition element and the longitudinal axis;
a lateral suction tube in fluid communication between the suction perforations and the suction passageway; and
a retraction shroud extending about the longitudinal axis and axially disposed at least between the spray capture element and the oral partition element.

2. A device as defined in claim 1 further comprising an aerosol shroud extending about the longitudinal axis, wherein the spray capture element is axially disposed between the retraction shroud and the aerosol shroud.

3. A device as defined in claim 2, wherein
(a) the spray capture element, the retraction shroud, and the aerosol shroud each extend completely circumferentially about the longitudinal axis, and
(b) the suction passageway is continuous.

4. A device as defined in claim 1 comprising two said oral partition elements and two respective said lateral suction tubes.

5. A device as defined in claim 4, wherein the oral partition elements are disposed oppositely of one another radially of the main axis.

6. A device as defined in claim 2 further comprising an auxiliary aerosol shroud extending about the longitudinal axis, wherein the aerosol shroud is axially disposed between the spray capture element and the auxiliary aerosol shroud.

7. A device as defined in claim 1 wherein the suction apertures are elongated.

8. A device as defined in claim 7 wherein the elongation is in an arcuate direction about the longitudinal axis.

9. A device as defined in claim 8 wherein the suction apertures have an aspect ratio of at least 3:1.

10. A device as defined in claim 4 wherein each oral partition element includes a bite block member.

11. A device as defined in claim 1 wherein the retraction shroud is comprised of a flexible sheet material.

12. A device as defined in claim 11 wherein the retraction shroud includes an inner periphery having a stiffener ring attached thereto.

13. A device as defined in claim 5 further comprising a tongue retraction element laterally affixed to the oral partition elements.

14. A device as defined in claim 13 further comprising a floor suction tube having one or more suction openings and being in fluid communication with the suction passageway.

15. A device as defined in claim 14 wherein
(a) the tongue retraction element includes a lower portion and an upper portion; and
(b) the floor suction tube is attached to the lower portion.
